(19) United States
(12) Patent Application Publication
(10) Pub. No.: US 2018/0315970 A1
(43) Pub. Date: Nov. 1, 2018

(54) NONAQUEOUS ELECTROLYTE SECONDARY BATTERY

(71) Applicant: TOYOTA JIDOSHA KABUSHIKI KAISHA, Toyota-shi, Aichi-ken (JP)

(72) Inventors: Junpei TERASHIMA, Toyota-shi, Aichi-ken (JP); Taira SAITO, Miyoshi-shi, Aichi-ken (JP); Ayumu KAMAKURA, Toyota-shi, Aichi-ken (JP); Harunari SHIMAMURA, Toyonaka-shi, Osaka (JP)

(73) Assignee: TOYOTA JIDOSHA KABUSHIKI KAISHA, Toyota-shi, Aichi-ken (JP)

(21) Appl. No.: 15/527,945

(22) PCT Filed: Nov. 17, 2015
(86) PCT No.: PCT/IB2015/002158

§ 371 Date: May 18, 2017

(30) Foreign Application Priority Data
Nov. 19, 2014 (JP) 2014-235005

(51) Int. Cl. H01M 2/16; H01M 10/0525; H01M 10/0587

(52) U.S. Cl. CPC H01M 2/1686; H01M 10/0525; H01M 2/166; H01M 2/1653; H01M 10/0587

(57) ABSTRACT

A nonaqueous electrolyte secondary battery includes: a flat wound electrode body in which an elongated positive electrode, an elongated negative electrode, and an elongated separator (70) which electrically separates the positive electrode and the negative electrode from each other overlap each other and are wound in a longitudinal direction; and a nonaqueous electrolyte. The separator (70) includes a substrate layer (90) which is formed of a resin substrate and a heat resistance layer (80) which is formed on one surface of the substrate layer (90), and an adhesion strength between the substrate layer (90) and the heat resistance layer (80) is 0.19 N/10 mm to 400 N/10 mm.

### BACKGROUND OF THE INVENTION

### 1. Field of the Invention

The present invention relates to a nonaqueous electrolyte secondary battery

### 2. Description of Related Art

A nonaqueous electrolyte secondary battery such as a lithium ion secondary battery (lithium secondary battery) has a lighter weight and higher energy density than existing batteries. Therefore, recently, a nonaqueous electrolyte secondary battery has been used as a so-called portable power supply for a PC, a portable device, or the like or as a drive power supply for a vehicle. In particular, a light-weight lithium ion secondary battery capable of obtaining high energy density is preferably used as a high-output power supply for driving a vehicle such as an electric vehicle (EV), a hybrid vehicle (HV), or a plug-in hybrid vehicle (PHV). Typically, such a secondary battery is constructed to have a structure in which an electrode body is accommodated in a case together with an electrolyte, the electrode body being obtained by laminating a positive electrode and a negative electrode with a separator interposed therebetween. As the structure of the electrode body, for example, a laminated electrode body in which plural planar electrode bodies are laminated or a wound electrode body in which an elongated sheet-shaped electrode body is spirally wound is known. By adopting such a configuration, the reaction area between the positive and negative electrodes increases, which can improve energy density and output.

Here, as the separator, typically, a porous resin film is used. The separator has a function of electrically insulating a positive electrode and a negative electrode from each other, a function of holding a nonaqueous electrolyte, and a shutdown function (that is, a function of being softened to interrupt a conductive path of charge carriers when the inside of a battery is overheated to higher than a given temperature range (typically, a softening point of the separator)). Further, in order to ensure the safety of a battery and a device where the battery is installed, the separator is required to have not only the above-described functions but also a function (short-circuiting preventing function) of preventing short-circuiting caused by contact between a positive electrode and a negative electrode. For example, when the inside of a battery is overheated to a softening point of a resin constituting the separator or higher such that the separator is thermally shrunk, short-circuiting may occur due to an insufficient coating range of an electrode caused by the separator or due to breakage (rupture) of the separator. Therefore, the separator is required to exhibit performance of suppressing the shrinkage of the separator to prevent internal short-circuiting even in a high-temperature environment, that is, to have a predetermined level of heat resistance (durability). As means for satisfying the above-described requirements, a configuration in which a separator includes a porous heat resistance layer (HRL) on a surface of a resin separator is disclosed. That is, a configuration including a substrate layer, which is formed of a porous resin film, and a porous heat resistance layer is disclosed. The heat resistance layer typically contains particles of an inorganic compound (inorganic filler) as a major component and has high heat resistance and insulating properties (non-conductivity). For example, Japanese Patent Application Publication No. 2014-120214 (JP 2014-120214 A) discloses a battery including: a separator in which a heat resistance layer containing an inorganic filler as a major component is formed on one surface (single surface) of a resin substrate layer; and a battery case that accommodates a wound electrode body including the separator.

### SUMMARY OF THE INVENTION

According to the investigation by the present inventors, the heat resistance of the separator can be improved by forming the heat resistance layer on the surface of the substrate layer; however, when the heat resistance layer is peeled off from the substrate layer, it is difficult to suppress the shrinkage of the separator at a portion where the heat resistance layer is peeled off, and the short-circuiting preventing function may be insufficiently exhibited. For example, when the battery is exposed to more severe conditions (for example, exposure to higher-temperature conditions such as a high-temperature environment for a long period of time), energy that shrinks the substrate layer is excessively high, and thus the heat resistance layer may be peeled off from the substrate layer. In addition, when the battery described in JP 2014-120214 A including the wound electrode body is exposed to a high-temperature environment, a portion of the substrate layer where the resin is exposed may be adhered (bonded) to a counter electrode, the wound electrode body including the separator in which the heat resistance layer is formed on one surface of the substrate layer. On the other hand, typically, a portion of the substrate layer which is not adhered to the electrode, or a surface of the substrate layer where the heat resistance layer is formed is likely to be shrunk in an inner peripheral direction of the wound electrode body. Therefore, in the separator, strains may be generated due to energy that shrinks the substrate layer, the heat resistance layer may be peeled off from the substrate layer at a portion where the energy is locally concentrated. In addition, according to the investigation by the present inventors, it was found that the heat resistance layer is likely to be peeled off from the substrate layer at curved portions of a flat wound electrode body and in the vicinity of boundaries between the curved portions and a flat portion (flat surface) thereof.

The invention provides a highly reliable nonaqueous electrolyte secondary battery in which the shrinkage of a separator is preferably suppressed in a high-temperature environment.

According to a first aspect of the invention, there is provided a nonaqueous electrolyte secondary battery including: a flat wound electrode body in which an elongated positive electrode, an elongated negative electrode, and an elongated separator which electrically separates the positive electrode and the negative electrode from each other overlap each other and are wound in a longitudinal direction; and a nonaqueous electrolyte. The separator includes a substrate layer which is formed of a resin substrate and a heat resistance layer which is provided on one surface of the substrate layer, and the heat resistance layer contains a filler and a binder. An adhesion strength between the substrate layer and the heat resistance layer is 0.19 N/10 mm to 400 N/10 mm.

In this specification, “nonaqueous electrolyte secondary battery” refers to batteries including a nonaqueous electrolyte (typically, a nonaqueous electrolytic solution containing a supporting electrolyte in a nonaqueous solvent (organic solvent)). In this specification, “secondary battery” refers to general batteries which can be repeatedly charged and discharged and includes chemical batteries such as a lithium ion secondary battery and so-called physical batteries such as an electric double layer capacitor.

In the nonaqueous electrolyte secondary battery provided according to the invention, as described above, the adhesion strength between the substrate layer and the heat resistance layer in the separator is set to be higher than an adhesion strength between a substrate layer and a heat resistance layer in a general separator used in a nonaqueous electrolyte secondary battery of the related art. By setting the adhesion strength to be within the above-described range, the peeling of the heat resistance layer from the substrate layer can be significantly suppressed. In particular, the peeling of the heat resistance layer from the substrate layer can be significantly suppressed even at curved portions of a flat wound electrode body and in the vicinity of boundaries between the curved portions and a flat portion (flat surface) thereof. In addition, when the adhesion strength between the substrate layer and the heat resistance layer in the separator is excessively high, the flexibility of the separator is excessively low (the stiffness of the separator is excessively high). Therefore, it is difficult wind the separator (that is, to prepare a wound electrode body using the separator). Alternatively, even if a wound electrode body is prepared using the separator, there may be problems such as the loosening of the wound state (winding failure), the cracking of the separator, or poor formability into a flat shape. That is, when the separator having an excessively high adhesion strength between the substrate layer and the heat resistance layer in the separator is used, the manufacturing failure of a wound electrode body occurs with high frequency. On the other hand, by adjusting the adhesion strength between the substrate layer and the heat resistance layer in the separator to be within the above-described range, when a wound electrode body is prepared using the separator, the handleability of the separator can be maintained. That is, the frequency of manufacturing failure, by producing a wound electrode body with the separator, can be suppressed to be low.

The adhesion strength described in this specification refers to 90 degree peeling strength which is measured according to JIS C 6481 (1996). A typical test method of measuring the adhesion strength (90 degree peeling strength) will be described below. Specifically, the separator is cut into a predetermined size (for example, 120 mm×10 mm) to prepare a rectangular test piece. In order to fix the substrate layer at one end of the test piece in a longitudinal direction to a tensile jig (for example, a clamp), the heat resistance layer at the end of the test piece in the longitudinal direction is peeled off from the substrate layer. The heat resistance layer surface of the test piece is fixed to a stand of a tensile testing machine using an adhesive such as a double-sided adhesive tape, and the heat resistance layer-peeled portion (substrate layer) of the test piece is fixed to the tensile jig. The tensile jig is pulled up at a predetermined rate (for example, 0.5 mm per second) to an upper side (peeling angle: 90±5°) in a direction perpendicular to a surface of the stand (that is, the heat resistance layer adhered to the stand) such that the heat resistance layer is peeled off from the substrate layer. At this time, an average load value in the period of time in which the substrate layer is peeled off from the heat resistance layer is measured, and an average load value per unit width (here, width: 10 mm) is set as the adhesion strength (N/10 mm).

The adhesion strength between the substrate layer and the heat resistance layer may be 0.58 N/10 mm to 98 N/10 mm. By adjusting the adhesion strength between the substrate layer and the heat resistance layer to be within the above-described range, the peeling of the heat resistance layer from the substrate layer can be significantly suppressed, and the flexibility of the separator which is suitable for the preparation of a wound electrode body can be ensured. Therefore, the shrinkage of the separator in a high-temperature environment can be significantly suppressed, and manufacturing failure which may occur during the preparation of a wound electrode body can be significantly reduced.

The flat wound electrode body may be obtained by winding the positive electrode, the negative electrode, and the separator in a cylindrical shape to obtain a wound electrode body and then pressing the wound electrode body in a direction perpendicular to a winding axis to be formed into a flat shape. The flat wound electrode body includes: a flat surface (flat portion); and curved portions that are provided at opposite ends of the flat surface. In the flat wound electrode body formed as described above, an external force (compressive stress) applied by the pressing is concentrated on the curved portions. Specifically, a part of the compressive stress applied to the electrode body is relaxed by changing the shape of a portion of the electrode body, to which the compressive stress is applied, from an arc shape to a substantially linear shape. On the other hand, compressive stress which remains in the electrode body without being relaxed moves from the portion (flat surface) of the electrode body to which the compressive stress is applied to portions (curved portions) of the electrode body to which the compressive stress is not applied. According to the investigation of the present inventors, it was found that, in the wound electrode body, the peeling of the heat resistance layer from the substrate layer is likely to occur, in particular, at the curved portions where the compressive stress is concentrated and in the vicinity of boundaries between the curved portions and the flat surface (flat portion) as described above. In particular, the peeling of the heat resistance layer from the substrate layer is likely to occur in a high-temperature environment (typically, in a temperature environment where the substrate layer may be thermally shrunk). In addition, it was found that, when a wound electrode body is prepared as described above, the manufacturing failure of an electrode body (for example, the cracking of the separator, or the peeling or cracking of the heat resistance layer) is likely to occur. Therefore, by applying the invention to the wound electrode body, the peeling of the heat resistance layer from the substrate layer can be significantly suppressed, and the manufacturing failure of the electrode body can be reduced.

According to a second aspect of the invention, there is provided a battery pack including the plural nonaqueous electrolyte secondary batteries according to the first aspect that are electrically connected to each other. In the battery pack, a wound electrode body included in each of the nonaqueous electrolyte secondary batteries is restrained at a restraining pressure of 100 N to 20000 N in a direction perpendicular to a flat surface of the wound electrode body, and a difference between a restraining force applied to curved portions of the wound electrode body and a restraining force applied to the flat surface is 50 N or higher. In the wound electrode body included in each of the nonaqueous electrolyte secondary batteries, in the above-described high-temperature environment, the peeling of the heat resistance layer from the substrate layer is more likely to occur at the curved portions where the restraining pressure is not applied and in the vicinity of the boundaries between the flat surface (flat portion) and the curved portions, rather than the flat surface (flat portion) which is restrained at the predetermined restraining pressure. In addition, the peeling of the heat resistance layer from the substrate layer in the separator is likely to occur when a difference between the restraining force applied to the curved portions of the wound electrode body and the restraining force applied to the flat surface (flat portion) is within the above-described range. Therefore, by applying the invention to the wound electrode body, the effects of the invention can be exhibited at a high level.

According to the invention, there is provided a vehicle including the nonaqueous electrolyte secondary battery according to the first aspect and/or the battery pack according to the second aspect. In the nonaqueous electrolyte secondary battery and the battery pack including the plural (for example, 10 or more, preferably 40 to 80) nonaqueous electrolyte secondary batteries as single cells disclosed herein, the thermal shrinkage of the separator is significantly suppressed, and thus reliability and durability are high. Therefore, using the above-described characteristics, the nonaqueous electrolyte secondary battery and the battery pack can be preferably used as a power supply (for example, a power source for driving a motor) for driving a vehicle (typically, a plug-in hybrid vehicle (PHV), a hybrid vehicle (HV), or an electric vehicle (EV)) in which high energy density, high output density, or high durability in a wide temperature range may be required.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram showing a section of a separator according to an embodiment of the invention;

FIG. 2 is a perspective view schematically showing the external appearance of a nonaqueous electrolyte secondary battery according to an embodiment of the invention;

FIG. 3 is a longitudinal sectional view schematically showing a sectional structure taken along line of FIG. 2;

FIG. 4 is a schematic diagram showing a configuration of a wound electrode body according to the embodiment;

FIG. 5 is an partially enlarged sectional view schematically showing a part of a region between positive and negative electrodes of the wound electrode body according to the embodiment; and

FIG. 6 is a perspective view schematically showing a battery pack which is a combination of the plural nonaqueous electrolyte secondary batteries according to the embodiment.

### DETAILED DESCRIPTION OF EMBODIMENTS

Preferred embodiments of the invention are described below. Matters necessary to implement the embodiments of the invention other than those specifically referred to in the invention may be understood as design matters based on the related art in the pertinent field for a person of ordinary skills in the art. The invention can be practiced based on the contents disclosed in this description and common technical knowledge in the subject field. In addition, in the following drawings, parts or portions having the same function are represented by the same reference numerals, and the repeated description thereof will not be made or will be simplified. In each drawing, a dimensional relationship (for example, length, width, or thickness) does not necessarily reflect the actual dimensional relationship.

Hereinafter, a separator according to a preferable embodiment of the invention will be described appropriately with reference to the drawings. The invention is not intended to be limited to the embodiment. For example, a shape (external shape or size) of the separator is not particularly limited.

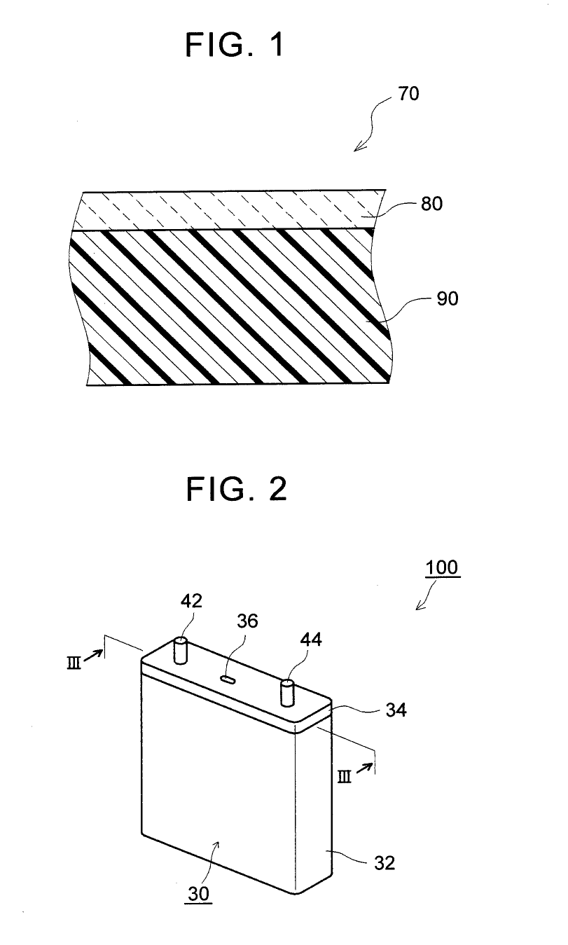

The separator for a nonaqueous electrolyte secondary battery disclosed herein may have the same configuration as in the related art, except that a heat resistance layer (HRL) which is a characteristic of the invention is provided. As shown in FIG. 1, a separator 70 includes: a substrate layer 90 which is formed of a porous separator substrate; and a heat resistance layer 80 which is formed one surface (single surface) of the substrate layer 90. Typically, the heat resistance layer 80 may be formed on the entire surface of the substrate layer 90, that is, the entire region of the substrate layer 90 in a longitudinal direction and a width direction thereof. The shape of the separator 70 is not particularly limited because it may vary depending on the shape and the like of a nonaqueous electrolyte secondary battery. For example, the separator 70 may have various shapes such as a rod shape, a plate shape, a sheet shape, and a foil shape. The separator 70 having the above-described configuration has a function of insulating a positive electrode (positive electrode active material layer) and a negative electrode (negative electrode active material layer) from each other, a function of holding an electrolyte, and a shutdown function. Hereinafter, the substrate layer (separator substrate) 90 and the heat resistance layer 80 will be described in detail.

As the separator substrate constituting the substrate layer 90, the same resin substrate as in a nonaqueous electrolyte secondary battery of the related art can be used. Preferable examples of the separator substrate include a porous resin sheet (film) containing a thermoplastic resin such as polyethylene (PE), polypropylene (PP), polyester, cellulose, or polyamide as a major component. Among these, the porous resin sheet (for example, PE or PP) containing a polyolefin resin as a major component has a shutdown temperature of 80° C. to 140° C. (typically 110° C. to 140° C.; for example, 120° C. to 135° C.) sufficiently lower than the heat resistance temperature (typically, about 200° C. or higher) of a battery, and thus can exhibit the shutdown function at an appropriate timing. Accordingly, a highly reliable battery can be realized.

The substrate layer 90 may have a single-layer structure or a structure in which two or more porous resin sheets formed of different materials or having different properties (for example, thickness or porosity) are laminated. For example, a PE single-layer sheet, a PP single-layer sheet, or a multi-layer sheet such as a sheet having a two-layer structure (PE/PP structure) in which a PE layer and a PP layer are laminated or a sheet having a three-layer structure (PP/PE/PP structure) in which a PP layer is laminated on both sides of a PE layer can be preferably used.

The thickness (average thickness) of the substrate layer 90 is not particularly limited. Typically, it is preferable that the thickness is 5 μm or more (typically 10 μm or more; for example 12 μm or more) and is 40 μm or less (typically 30 μm or less; for example, 25 μm or less). When the thickness of the substrate layer 90 is within the above-described range, the insulating function and the function of holding the electrolyte can be suitably exhibited, and far superior ion permeability can be maintained. Therefore, far superior battery performance can be realized. The thickness of the substrate layer 90 can be obtained, for example, by measurement using a micrometer or a thickness meter or by analysis of a sectional SEM image.

Even when the internal temperature of a battery becomes high (for example, 150° C. or higher; typically 200° C. or higher) due to, for example, internal short-circuiting, the heat resistance layer 80 may have a shape retaining ability (which can allow a small amount of deformation) without being softened or melted. The heat resistance layer 80 disclosed herein contains a filler and a binder.

The filler contained in the heat resistance layer 80 may be an organic filler, an inorganic filler, or a combination of an organic filler and an inorganic filler. From the viewpoints of heat resistance, durability, dispersibility, stability, and the like, an inorganic filler is preferably used.

The inorganic filler is not particularly limited, and examples thereof include a metal oxide and a metal hydroxide. Specific examples of the inorganic filler include: inorganic oxides such as alumina (aluminum oxide; Al₂O₃), boehmite (Al₂O₃.H₂O), silica (silicon oxide; SiO₂), titania (titanium oxide: TiO₂), zirconia (zirconium dioxide: ZrO₂), calcia (calcium oxide: CaO), magnesia (magnesium oxide; MgO), or barium titanate (BaTiO₃), and iron oxide; inorganic nitrides such as silicon nitride (Si₃N₄) and aluminum nitride (AlN); elementary materials such as silicon, aluminum, and iron; and mineral materials such as talc, clay, mica, bentonite, montmorillonite, zeolite, apatite, kaolin, mullite, and sericite. Among these inorganic fillers, one kind can be used alone, or two or more kinds can be used in combination. In particular, alumina, boehmite, silica, titania, zirconia, calcia, or magnesia is preferable; and alumina, boehmite, titania, silica, or magnesia is more preferable. These compounds have a high melting point and superior heat resistance. In addition, the compounds have a relatively high Mohs' hardness and superior durability (mechanical strength). Further, since the compounds are relatively cheap, the material cost can be reduced. In particular, among the metals, aluminum has a relatively low specific gravity and thus can realize reduction in the weight of the battery and can exhibit the effects of the invention at a higher level.

Examples of the organic filler include high heat-resistant resin particles such as aramid, polyimide, polyamide imide, polyethersulfone, polyetherimide, polycarbonate, polyacetal, polyether ether ketone, polyphenylene ether, and polyphenylene sulfide.

When the inorganic filler and the organic filler are used in combination, a mixing ratio (inorganic filler:organic filler) is not particularly limited and is preferably 10:90 to 90:10 (typically, 20:80 to 70:30; for example, 30:70 to 60:40) in terms of mass.

The form of the filler is not particularly limited and, for example, may be particulate, fibrous, or plate-like (flaky). The average particle size of the filler is not particularly limited and is suitably 0.01 μm to 5 μm (for example, 0.05 μm to 2 μm; typically 0.1 μm to 1 μm) from the viewpoints of dispersibility and the like. When the particle size of the filler is within the above-described range, the adhesion strength of the heat resistance layer 80 to the substrate layer 90 can be adjusted within a preferable range. In this specification, the average particle size of the filler refers to a particle size (also referred to as “D₅₀ particle size” or “median size”) corresponding to a cumulative value of 50 vol % in order from the smallest particle size in a volume particle size distribution which is obtained by particle size distribution measurement based on a general laser diffraction laser scattering method. The particle size of the inorganic filler can be adjusted using a method such as crushing or sieving.

The specific surface area of the filler is not particularly limited and is preferably about 1 m²/g to 100 m²/g (for example, 1.5 m²/g to 50 m²/g; typically, 5 m²/g to 20 m²/g). When the specific surface area of the filler is within the above-described range, the adhesion strength of the heat resistance layer 80 to the substrate layer 90 can be adjusted within a preferable range. Here, “specific surface area” refers to a general BET specific surface area.

Examples of the binder contained in the heat resistance layer 80 include: acrylic resins obtained by polymerization of a monomer component containing an alkyl (meth)acrylate (preferably, an alkyl (meth)acrylate in which the number of carbon atoms in an alkyl group is 1 to 14 (typically 2 to 10)) as a major component, examples of the alkyl (meth)acrylate includes methyl acrylate, methyl methacrylate, ethyl acrylate, ethyl methacrylate, butyl acrylate, and 2-ethylhexyl acrylate; polyolefin resins such as polyethylene (PE); fluororesins such as polytetrafluoroethylene (PTFE); vinyl halide resins such as polyvinylidene fluoride (PVdF); cellulose resins such as carboxymethyl cellulose (CMC) or methyl cellulose (MC); rubbers containing acrylonitrile as a copolymerization component, such as acrylonitrile-butadiene copolymer rubber (NBR), acrylonitrile-isoprene copolymer rubber (NIR), and acrylonitrile-butadiene-isoprene copolymer rubber (NBIR); polyvinyl pyrrolidone (PVP) resins; poly(N-vinylacetamide) (PNVA) resins; epoxy resins; and styrene-butadiene rubber (SBR). As the binder contained in the heat resistance layer 80, one kind alone or two or more kinds can be appropriately selected among the above-described binders. In particular, an acrylic resin is preferable because it can exhibit high shape retaining ability due to strong adhesion (typically, initial tackiness or adhesion strength) and high electrochemical stability thereof. By appropriately selecting the kind and combination of the binder used for forming the heat resistance layer 80, the adhesion strength of the heat resistance layer 80 to the substrate layer 90 can be adjusted to be within a desired range.

Monomer components used for the polymerization of the acrylic resin may include a well-known monomer such as a carboxyl group-containing vinyl monomer such as acrylic acid or methacrylic acid; an amide group-containing vinyl monomer such as acrylamide or methacrylamide; and a hydroxyl group-containing vinyl monomer such as 2-hydroxyethyl acrylate or 2-hydroxyethyl methacrylate. A mixing ratio of the above monomer is not particularly limited and may be lower than 50 mass % (for example, 30 mass % or lower; typically 10 mass % or lower) with respect to all the monomer components. The acrylic resin may be any one of a homopolymer obtained by polymerization of one monomer, a copolymer obtained by polymerization of two or more monomers, and a mixture of two or more kinds selected from the above-described homopolymers and copolymers. A part of the acrylic resin may be modified to obtain a modified acrylic resin.

The form of the binder is not particularly limited. The particulate (powdered) binder may be used without any change, or a solution or an emulsion prepared using the particulate binder may be used. Two or more binders having different forms may be used. When a particulate binder is used, the average particle size thereof is not particularly limited. For example, a particulate binder having an average particle size of 0.05 μm to 0.5 μm can be used.

A mass ratio (in terms of NV, that is, in terms of solid content) of the binder to the filler in the heat resistance layer 80 is, for example, 90:10 to 99.8:0.2 and is preferably 93:7 to 99.5:0.5 and more preferably 93:7 to 99:1. When the mass ratio of the binder to the filler is within the above-described range, the adhesion strength of the heat resistance layer 80 to the substrate layer 90 can be adjusted to be within a desired range. When the ratio of the binder to the filler is excessively low, an anchoring effect of the heat resistance layer 80 or the strength (shape retaining ability) of the heat resistance layer decreases, which may cause problems such as cracking or peeling. When the ratio of the binder to the filler is excessively high, the porousness of the heat resistance layer 80 or the ion permeability of the separator 70 may deteriorate. In a preferable embodiment, a ratio of the total mass of the filler and the binder to the total mass of the heat resistance layer 80 is about 90 mass % or higher (for example, 95 mass % or higher). The heat resistance layer may consist of substantially only the filler and the binder. The mass ratio of the binder to the filler in the heat resistance layer 80 can be adjusted to a predetermined ratio by setting a mixing ratio (in terms of mass) of the binder to the filler in the heat resistance layer 80 to the predetermined ratio during the preparation of a heat resistance layer-forming composition described below.

In addition to the filler and the binder, the heat resistance layer 80 optionally contains one material or two or more materials which can be used as components of a heat resistance layer in a general secondary battery. Examples of the material include various additives such as a thickener or a dispersant.

A ratio of the mass of the filler to the total mass of the heat resistance layer 80 is suitably about 50 mass % or higher. Typically, it is preferable that the mass ratio of the filler is 80 mass % or higher (for example, 85 mass % or higher) and 99.8 mass % or lower (for example, 99 mass % or lower). A ratio of the mass of the binder to the total mass of the heat resistance layer 80 is, for example, about 0.2 mass % to 15 mass %. Typically, it is preferable that the mass ratio of the binder is preferably 0.5 mass % to 8 mass %. When various additives are used, a ratio of the mass of the additives to the total mass of the heat resistance layer 80 is, for example, about 0.2 mass % to 10 mass %. Typically, it is preferable that the mass ratio of the additives is about 0.5 mass % to 5 mass %.

The thickness (average thickness) of the heat resistance layer 80 is not particularly limited. Typically, it is preferable that the thickness of the heat resistance layer 80 in the dry state is 1 μm or more (for example, 1.5 μm or more; typically, 2 μm or more). When the thickness of the heat resistance layer 80 is excessively small, a sufficient heat resistance effect cannot be exhibited, and the short-circuiting preventing effect may decrease. The upper limit of the thickness of the heat resistance layer 80 in the dry state is not particularly limited. Typically, it is preferable that the upper limit is 20 μm or less (for example, 10 μm or less; typically, 6 μm or less). When the thickness of the heat resistance layer 80 is excessively large, the handleability or workability of the separator 70 may deteriorate. Therefore, manufacturing failure is likely to occur when a wound electrode body is prepared using the separator. When the thickness of the heat resistance layer 80 is excessively large, the flexibility of the heat resistance layer deteriorates, and thus problems such as cracking or peeling are likely to occur. Therefore, by adjusting the thickness of the heat resistance layer 80 to be within the above-described range, a high short-circuiting preventing effect can be exhibited, and manufacturing failure which may occur when a wound electrode body is prepared using the separator can be suppressed. The thickness of the heat resistance layer 80 can be obtained, for example, by analyzing an image which is obtained using a scanning electron microscope (SEM).

A total porosity of the heat resistance layer 80 is not particularly limited and may be, for example, 75 vol % or higher (typically 78 vol % or higher; for example, 80 vol % or higher) and 90 vol % or lower (typically 85 vol % or lower). When the porosity of the heat resistance layer 80 is excessively high, mechanical strength may be insufficient. When the porosity of the heat resistance layer is excessively low, resistance may increase due to reduced ion permeability, or input and output characteristics may decrease. Within the above-described range, the effects of the invention can be exhibited at a higher level.

The porosity of the heat resistance layer can be calculated as follows. The apparent volume of the heat resistance layer per unit surface area is represented by V1 (cm³). A ratio W/ρ of the mass W (g) of the heat resistance layer to the true density ρ (g/cm³) of a material constituting the heat resistance layer is represented by V0. At this time, the porosity of the heat resistance layer can be calculated from (V1−V0)/V1×100. In order to calculate the apparent volume V1, the thickness of the heat resistance layer 80 is necessary. The thickness of the heat resistance layer 80 can be obtained, for example, by analyzing an image which is obtained using a scanning electron microscope (SEM). The mass W of the heat resistance layer can be measured as follows. That is, the separator is cut into a predetermined area to obtain a sample, and the mass of the sample is measured. Next, the mass of the heat resistance layer having the predetermined area can be calculated by subtracting the mass of the substrate layer having the predetermined area from the mass of the sample. The mass of the heat resistance layer calculated as described above is converted into the mass per unit area. As a result, the mass W (g) of the heat resistance layer can be calculated.

The adhesion strength (90 degree peeling strength) of the heat resistance layer 80 to the substrate layer 90 is 0.19 N/10 mm or higher (preferably 0.21 N/10 mm or higher, more preferably 0.58 N/10 mm or higher, and still more preferably 0.80 N/10 mm or higher; typically, 0.82 N/10 mm or higher; for example, 1.18 N/10 mm or higher). By adjusting the adhesion strength of the heat resistance layer 80 to the substrate layer 90 to be within the above-described range, the peeling of the heat resistance layer 80 from the substrate layer 90 can be significantly suppressed. In particular, in a high-temperature environment in which the substrate layer 90 is thermally shrunk, the peeling of the heat resistance layer 80 from the substrate layer 90 can be suitably suppressed. Therefore, by adjusting the adhesion strength (90 degree peeling strength) of the heat resistance layer 80 to the substrate layer 90 to be within the above-described range, an effect of suppressing the shrinkage (typically, thermal shrinkage) of the separator 70 can be exhibited at a high level. As the adhesion strength (90 degree peeling strength) of the heat resistance layer 80 to the substrate layer 90 increases, an effect of suppressing the peeling of the heat resistance layer 80 from the substrate layer 90 (that is, the effect of suppressing the shrinkage of the separator) can be exhibited at a higher level. The adhesion strength (90 degree peeling strength) of the heat resistance layer 80 to the substrate layer 90 is, for example, 400 N/10 mm or lower (preferably 98 N/10 mm or lower and more preferably 50 N/10 mm or lower). By adjusting the adhesion strength of the heat resistance layer 80 to the substrate layer 90 to be within the above-described range, manufacturing failure which may occur when a wound electrode body is prepared using the separator 70 including the heat resistance layer 80 can be significantly suppressed. Therefore, the separator 70 including the heat resistance layer 80 can be preferably used for the construction of a wound electrode body. As the adhesion strength (90 degree peeling strength) of the heat resistance layer 80 to the substrate layer 90 decreases, it is easier to maintain the flexibility of the separator. Therefore, when a wound electrode body is manufactured using the separator, the handleability of the separator is superior. Typically, the adhesion strength of the heat resistance layer 80 to the substrate layer 90 can be adjusted based on, for example, the kind of the binder used for forming the heat resistance layer and the ratio of the binder to the heat resistance layer (typically, the ratio of the binder to the filler in the heat resistance layer).

The adhesion strength described in this specification refers to 90 degree peeling strength which is measured according to JIS C 6481 (1996).

The separator 70 in which the heat resistance layer 80 is formed on the substrate layer 90 (separator substrate) can be manufactured, for example, using the following method. First, the filler, the binder, and other optional materials are dispersed in an appropriate solvent to prepare a paste-like or slurry-like composition. The composition for forming the heat resistance layer is applied to the surface of the substrate layer 90 and dried. As a result, the heat resistance layer 80 can be formed.

A solvent for dissolving or dispersing the filler and the binder is not particularly limited and can be appropriately selected from, for example, water, alcohols such as ethanol, N-methyl-2-pyrrolidone (NMP), toluene, dimethyl carbonate (DMC), and ethyl methyl carbonate (EMC). The solvent can be appropriately selected depending on the kinds of the filler and the binder.

A method of coating the heat resistance layer-forming composition to the substrate layer 90 is not particularly limited, and examples thereof include methods using a die coater, a gravure coater, a reverse roll coater, a kiss roll coater, a dip roll coater, a bar coater, an air knife coater, a spray coater, a brush coater, or a screen coater.

The drying step after the application can be performed by appropriately selecting a well-known method of the related art. Examples of a drying method include a drying method of maintaining the substrate layer at a temperature (for example, 70° C. to 100° C.) lower than a melting point of the substrate layer and a drying method of maintaining the substrate layer at a low temperature under reduced pressure.

Hereinafter, the nonaqueous electrolyte secondary battery according to the preferable embodiment of the invention will be described by using a lithium ion secondary battery as an example while appropriately referring to the drawings. However, the invention is not intended to be limited to the embodiment. The shape (external appearance and size) of the nonaqueous electrolyte secondary battery is not particularly limited. In the following embodiment, a nonaqueous electrolyte secondary battery (lithium ion secondary battery) having a configuration in which a wound electrode body and an electrolytic solution are accommodated in a square battery case will be described as an example. The lithium ion secondary battery is merely exemplary, and the technical idea of the invention can also be applied to other nonaqueous electrolyte secondary batteries (for example, a magnesium secondary battery) including other charge carriers (for example, magnesium ions).

The lithium ion secondary battery disclosed herein can adopt the same configuration as in the related art, except that it includes the separator which is a characteristic of the invention, that is, the separator including the heat resistance layer which is a characteristic of the invention. As the separator, the above-described separator can be used.

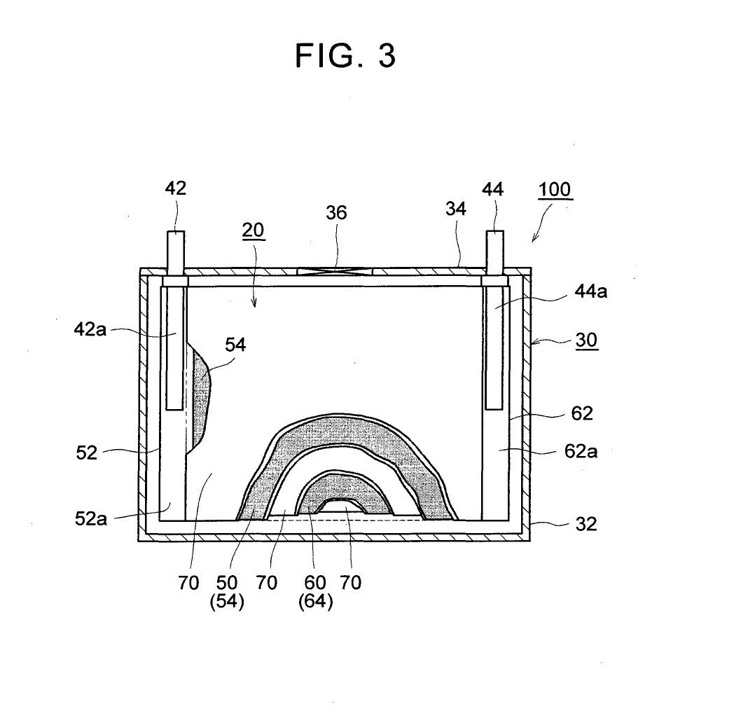

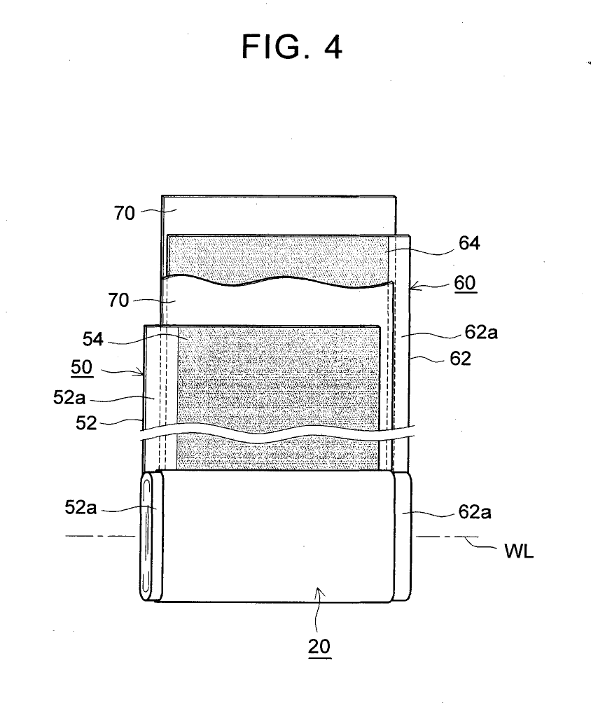

As shown in FIGS. 2 and 3, in a lithium ion secondary battery (nonaqueous electrolyte secondary battery) 100 according to the embodiment, a flat wound electrode body 20 and a nonaqueous electrolyte (not shown) are accommodated in a battery case 30 (that is, an external case). The battery case 30 includes: a box-shaped (that is, a bottomed rectangular parallelepiped-shaped) case body 32 having an opening at an end (corresponding to an upper end in a normal operating state of the battery); and a lid 34 that seals the opening of the case body 32. As shown in FIG. 4, the wound electrode body 20 is accommodated in the battery case 30 (that is, the case body 32 of the battery case) in a posture in which a winding axis WL of the wound electrode body 20 lies sideways (that is, the opening is formed in the normal direction of the winding axis WL of the wound electrode body 20). As the material of the battery case 30, for example, a light-weight and highly thermally conductive metal material such as aluminum, stainless steel, or nickel-plated steel may be preferably used. As shown in FIGS. 2 and 3, a positive electrode terminal 42 and a negative electrode terminal 44 for external connection are provided on the lid 34. In addition, a safety valve 36 and an injection hole (not shown) through which the nonaqueous electrolyte (typically, a nonaqueous electrolytic solution) is injected into the battery case 30 are provided on the lid 34. The safety valve 36 is set to release an internal pressure of the battery case 30 when the internal pressure increases to be a predetermined level or higher. In the battery case 30, the lid 34 is welded to the periphery of an opening of the case body 32 of the battery case. As a result, the case body 32 and the lid 34 of the battery case can be joined to each other (a boundary therebetween can be sealed).

As shown in FIGS. 3 and 4, the wound electrode body 20 is formed in which a laminate is wound in a longitudinal direction. In the laminate, a positive electrode 50 (positive electrode sheet) and a negative electrode 60 (negative electrode sheet) are laminated (are disposed to overlap each other) with two elongated separators 70 (separator sheets) interposed therebetween. In the positive electrode 50 (the positive electrode sheet), a positive electrode active material layer 54 is formed on a single surface or both surfaces (herein, both surfaces) of an elongated positive electrode current collector 52 in the longitudinal direction. In the negative electrode 60 (negative electrode sheet), a negative electrode active material layer 64 is formed on a single surface or both surfaces (herein, both surfaces) of an elongated negative electrode current collector 62 in the longitudinal direction.

A method of preparing the flat wound electrode body 20 is not particularly limited. For example, a laminate in which the positive and negative electrodes and the separator overlap each other is wound in a true-circle cylindrical shape in section. Next, the cylindrical wound electrode body is squashed (pressed) in a direction (typically, from the side surface thereof) perpendicular to the winding axis WL so as to be formed into a flat shape. In the wound electrode body 20 which is formed into a flat shape using the above-described method, the heat resistance layer 80 is likely to be peeled off from the substrate layer 90 in the separator, in particular, at curved portions and in the vicinity of boundaries between the curved portions and a flat surface (flat portion). The heat resistance layer 80 is likely to be peeled off from the substrate layer 90 in the separator when the wound electrode body is formed into a flat shape (during the pressing) and when the wound electrode body is exposed to a high-temperature environment (typically, a temperature environment where the substrate layer 90 can be thermally shrunk). During the pressing, manufacturing failure such as the cracking of the separator 70, the peeling or cracking of the heat resistance layer 80, and winding failure is likely to occur. Therefore, the above-described configuration is preferable as an application target of the invention. By forming the wound electrode body into a flat shape, the flat wound electrode body can be suitably accommodated in the battery case 30 having a box shape (that is, a bottomed rectangular parallelepiped shape) shown in FIG. 2. As the winding method, for example, a method of winding the positive and negative electrodes and the separator around the cylindrical winding axis can be preferably adopted.

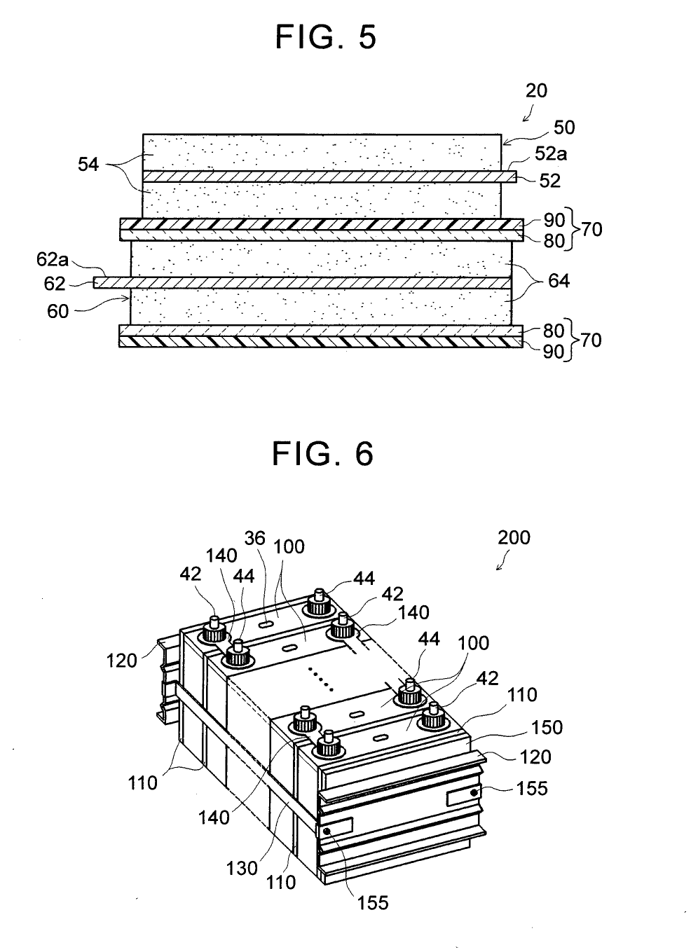

Here, a laminating direction of the separator 70 (direction facing the heat resistance layer 80 of the separator 70) is not particularly limited. The heat resistance layer 80 formed on one surface of the separator 70 may face any one of the negative electrode active material layer 64 and the positive electrode active material layer 54. In the embodiment, as shown in FIG. 5, the heat resistance layer 80 faces the negative electrode active material layer 64. The separator 70, the positive electrode 50 and negative electrode 60 are laminated such that the heat resistance layer 80 faces the negative electrode active material layer 64. As a result, for example, when the negative electrode active material (negative electrode) generates heat due to overcharge or the like, the substrate layer 90 in the separator can be protected from the generated heat. On the other hand, the separator 70, the positive electrode 50 and negative electrode 60 are laminated such that the heat resistance layer 80 faces the positive electrode active material layer 54. As a result, direct contact between the positive electrode 50 and the substrate layer 90 of the separator 70 is prevented, and thus the separator substrate can be prevented from being oxidized by the positive electrode.

Although not particularly limited thereto, as shown in FIGS. 3 and 4, the wound electrode body 20 may have a configuration in which the positive electrode 50, the negative electrode 60, and the separators 70 are disposed to overlap each other and are wound such that a positive electrode active material layer non-forming portion 52a (that is, a portion where the positive electrode current collector 52 is exposed without the positive electrode active material layer 54 being formed) and a negative electrode active material layer non-forming portion 62a (that is, a portion where the negative electrode current collector 62 is exposed without the negative electrode active material layer 64 being formed) protrude to the outside from opposite ends in a winding axial direction. As a result, at the center of the wound electrode body 20 in the winding axial direction, a winding core is formed in which the positive electrode 50 (the positive electrode sheet), the negative electrode 60 (the negative electrode sheet), and the separator sheets 70 are laminated and wound. As shown in FIG. 3, in the positive electrode 50 and the negative electrode 60, the positive electrode active material layer non-forming portion 52a and the positive electrode terminal 42 (for example, formed of aluminum) are electrically connected to each other through a positive electrode current collector plate 42a; and the negative electrode active material layer non-forming portion 62a and the negative electrode terminal 44 (for example, formed of nickel) are connected to each other through the negative electrode current collector plate 44a. The positive and negative electrode current collectors 42a, 44a and the positive and negative electrode active material layer non-forming portions 52a, 62a (typically, the positive and negative electrode current collectors 52, 62) are joined to each other by, for example, ultrasonic welding or resistance welding.

Here, the positive electrode 50 and the negative electrode 60 may have the same configuration as in a nonaqueous electrolyte secondary battery (lithium ion secondary battery) of the related art without any particular limitation. A typical configuration will be described below.

The positive electrode 50 of the lithium ion secondary battery disclosed herein includes the positive electrode current collector 52; and the positive electrode active material layer 54 that is formed on the positive electrode current collector 52. As the positive electrode current collector 52, a conductive material formed of highly conductive metal (for example, aluminum, nickel, titanium, or stainless steel) can be preferably used. The positive electrode active material layer 54 contains at least a positive electrode active material. As the positive electrode active material, one kind or two or more kinds may be used without any particular limitation among various known materials which can be used as a positive electrode active material of a nonaqueous electrolyte secondary battery. Preferable examples of the positive electrode active material include lithium composite metal oxides having a layered structure or a spinel structure (for example, LiNi_{1/3}Co_{1/3}Mn_{1/3}O₂, LiNiO₂, LiCoO₂, LiFeO₂, LiMn₂O₄, LiNi_{0.5}Mn_{1.5}O₄, and LiFePO₄). The positive electrode active material layer 54 may further contain components other than the positive electrode active material, for example, a conductive material or a binder. As the conductive material, for example, a carbon material such as carbon black (for example, acetylene black (AB)) or graphite may be preferably used. As the binder, for example, PVdF may be used.

The positive electrode 50 can be manufactured, for example, using the following method. First, the positive electrode active material and other optional materials are dispersed in an appropriate solvent (for example, N-methyl-2-pyrrolidone) to prepare a paste-like (slurry-like) composition. Next, an appropriate amount of the composition is applied to a surface of the positive electrode current collector 52 and then is dried to remove the solvent. As a result, the positive electrode 50 can be formed. In addition, by optionally performing an appropriate pressing treatment, the characteristics (for example, average thickness, active material density, and porosity) of the positive electrode active material layer 54 can be adjusted.

The negative electrode 60 of the lithium ion secondary battery disclosed herein includes the negative electrode current collector 62; and the negative electrode active material layer 64 that is formed on the negative electrode current collector 62. As the negative electrode current collector 62, a conductive material formed of highly conductive metal (for example, copper, nickel, titanium, or stainless steel) can be preferably used. The negative electrode active material layer 64 contains at least a negative electrode active material. As the negative electrode active material, one kind or two or more kinds may be used without any particular limitation among various known materials which can be used as a negative electrode active material of a nonaqueous electrolyte secondary battery. Preferable examples of the negative electrode active material include various carbon materials at least part of which has a graphite structure (layered structure), for example, graphite, non-graphitizable carbon (hard carbon), graphitizable carbon (soft carbon), carbon nanotube, and a carbon material having a combination thereof. Among these, natural graphite (plumbago) or artificial graphite is preferably used from the viewpoint of obtaining high energy density. The negative electrode active material layer 64 may further contain components other than the active material, for example, a binder or a thickener. As the binder, for example, various polymer materials such as styrene-butadiene rubber (SBR) may be used. As the thickener, for example, various polymer materials such as carboxymethyl cellulose (CMC) may be used.

The negative electrode 60 can be manufactured, for example, using the same method as in the positive electrode. That is, the negative electrode active material and other optional materials are dispersed in an appropriate solvent (for example, ion exchange water) to prepare a paste-like (slurry-like) composition. Next, an appropriate amount of the composition is applied to a surface of the negative electrode current collector 62 and then is dried to remove the solvent. As a result, the negative electrode 60 can be formed. In addition, by optionally performing an appropriate pressing treatment, the characteristics (for example, average thickness, active material density, and porosity) of the negative electrode active material layer 64 can be adjusted.

In the nonaqueous electrolyte disclosed herein, typically, an appropriate nonaqueous solvent (typically, organic solvent) may contain a supporting electrolyte. For example, a nonaqueous electrolyte which is liquid at a normal temperature (that is, nonaqueous electrolytic solution) can be preferably used.

As the nonaqueous solvent, various organic solvents which are used in a general nonaqueous electrolyte secondary battery can be used without any particular limitation. As the nonaqueous solvent, aprotic solvents such as carbonates, ethers, esters, nitriles, sulfones, and lactones can be used without any particular limitation. In particular, carbonates such as ethylene carbonate (EC), diethyl carbonate (DEC), dimethyl carbonate (DMC), ethyl methyl carbonate (EMC), and propylene carbonate (PC) can be preferably used. Alternatively, fluorine-based solvents, for example, fluorinated carbonates such as monofluoroethylene carbonate (MFEC), difluoroethylene carbonate (DFEC), monofluoromethyl difluoromethyl carbonate (F-DMC), and trifluoro dimethyl carbonate (TFDMC) can be preferably used.

As the supporting electrolyte, for example, a lithium salt or a sodium salt can be used. For example, in the lithium ion secondary battery in which lithium ions are used as charge carriers, lithium salts such as LiPF₆, LiClO₄, LiAsF₆, Li(CF₃SO₂)₂N, LiBF₄, and LiCF₃SO₃ can be preferably used. Among these supporting electrolytes, one kind can be used alone, or two or more kinds can be used in combination. In particular, LiPF₆ is preferable. The concentration of the supporting electrolyte is not particularly limited. However, when the concentration is extremely low, the amount of charge carriers (typically, lithium ions) contained in the nonaqueous electrolytic solution is insufficient, and the ion conductivity tends to decrease. When the concentration is extremely high, the viscosity of the nonaqueous electrolytic solution increases in a temperature range of room temperature or lower (for example, 0° C. to 30° C.), and the ion conductivity tends to decrease. Therefore, the concentration of the supporting electrolyte is 0.1 mol/L or higher (for example, 0.8 mol/L or higher) and is 2 mol/L or lower (for example, 1.5 mol/L or lower). The concentration of the supporting electrolyte is preferably 1.1 mol/L.

The nonaqueous electrolyte may further contain optional components other than the nonaqueous solvent and the supporting electrolyte within a range where the effects of the invention do not significantly deteriorate. These optional components may be used for one or two or more of the following purposes including: improvement of battery output performance; improvement of storability (prevention of a decrease in capacity during storage); improvement of cycle characteristics; and improvement of initial charge-discharge efficiency. Preferable examples of the additives include various additives, for example, a gas producing agent such as biphenyl (BP) or cyclohexylbenzene (CHB); a film forming agent such as oxalato complex compounds, fluorophosphates (typically, difluorophosphates; for example, lithium difluorophosphate), vinylene carbonate (VC), and fluoroethylene carbonate (FEC); a dispersant; and a thickener. Among these additives, one kind can be used alone, or two or more kinds can be used in combination.

Next, an example of a battery pack 200 (typically, a battery pack in which plural single cells are connected to each other in series) will be described, in which the lithium ion secondary battery (nonaqueous electrolyte secondary battery) 100 is used as a single cell, and the plural single cells are provided. As shown in FIG. 6, in the battery pack 200, among the plural (typically 10 or more and preferably about 10 to 30; for example 20) lithium ion secondary batteries (single cells) 100, every other one is reversed such that the positive electrode terminals 42 and the negative electrode terminals 44 are alternately arranged, and are arranged in a direction (laminating direction) in which wide surfaces of the battery cases 30 face each other. Cooling plates 110 having a predetermined shape are interposed between the arranged single cells 100. The cooling plate 110 functions as a heat dissipation member for efficiently dissipating heat generated from each of the single cells 100 during use and, preferably, has a shape capable of introducing cooling fluid (typically air) between the single cells 100 (for example, a shape in which plural parallel grooves vertically extending from one end of the rectangular cooling plate to an opposite end thereof are provided on the surface of the cooling plate 110). The cooling plate 110 is preferably formed of metal having high thermal conductivity, light-weight hard polypropylene, or another synthetic resin.

A pair of end plates (restraining plates) 120 are arranged at opposite end portions of an arranged body including the single cells 100 and the cooling plates 110. One or plural sheet-shaped spacer members 150 as length adjusting means may be interposed between the cooling plates 110 and the end plates 120. The single cells 100, the cooling plates 110, the spacer members 150 which are arranged are restrained by a restraining band 130 such that a predetermined restraining pressure is applied in the laminating direction, the restraining band 130 being attached to bridge between the two end plates 120. Specifically, by fastening and fixing end portions of the restraining band 130 to the end plates 120 through screws 155, the single cells and the like are restrained such that a predetermined restraining pressure is applied in the arrangement direction. As a result, the restraining pressure is also applied to the wound electrode body 20 which is accommodated in the battery case 30 of each of the single cells 100. In the adjacent two single cells 100, the positive electrode terminal 42 of one single cell is electrically connected to the negative electrode terminal 44 of another single cell through a connection member (bus bar) 140. By connecting the single cells 100 to each other in series, the battery pack 200 having a desired voltage is constructed.

It is preferable that the restraining pressure at which each of the single cells 100 is restrained is set such that a predetermined restraining pressure is applied to the wound electrode body 20 included in each of the single cells 100. For example, in each of the wound electrode bodies 20, it is preferable that each single cell is restrained such that a restraining pressure of 100 N to 20000 N is applied in a direction perpendicular to the flat surface (flat portion) of the wound electrode body 20. Typically, by restraining each of the arranged single cells 100 at a restraining pressure of 100 N to 20000 N in the arrangement direction (laminating direction) of the single cells, the same restraining pressure can be applied to the wound electrode body 20 included in each of the single cells. That is, typically, by restraining each of the single cells 100 at the same restraining pressure as that applied to the wound electrode body, a predetermined restraining pressure is applied to the wound electrode body. At this time, it is preferable that the restraining pressure at which each of the single cells (the wound electrode body included in each of the single cells) is restrained is set such that a difference between the restraining force applied to the flat surface (flat portion) of the wound electrode body 20 and the restraining force applied to the curved portions of the wound electrode body 20 is 50 N or higher (preferably 100 N or higher).

The separator (separator in which the heat resistance layer is formed on one surface of the substrate layer) disclosed herein is characterized in that the peeling of the heat resistance layer from the substrate layer is suppressed even when being exposed to an environment (typically, a high-temperature environment) where the substrate layer (separator substrate) is shrunk. Therefore, the shrinkage of the separator in a high-temperature environment is significantly suppressed. In the battery including the separator, the shrinkage of the separator is suppressed (typically, internal short-circuiting caused by the shrinkage of the separator is suppressed), and reliability is high. Accordingly, due to its characteristics, the nonaqueous electrolyte secondary battery disclosed herein can be preferably used as a drive power supply mounted in a vehicle such as a plug-in hybrid vehicle (PHV), a hybrid vehicle (HV), or an electric vehicle (EV). According to the invention, there can be provided a vehicle including the nonaqueous electrolyte secondary battery disclosed herein, preferably, as a power source (typically, a battery pack in which plural secondary batteries are electrically connected to each other).

Hereinafter, several examples relating to the invention will be described, but the examples are not intended to limit the invention.

Using the following materials and processes, separators (that is, separators according to Examples 1 to 15) used for the construction of lithium ion secondary batteries (nonaqueous electrolyte secondary batteries) according to Examples 1 to 15 shown in Table 1 were prepared.

First, as a separator substrate (substrate layer), a microporous film (average thickness: 20 μm) having a three-layer structure of PP/PE/PP including polypropylene (PP) and polyethylene (PE) was prepared.

The separator according to Example 1 was prepared in the following procedure. First, alumina (average particle size (D₅₀): 0.2 μm, BET specific surface area: 9 m²/g) as an inorganic filler; an acrylic resin as a binder; and carboxymethyl cellulose (CMC) as a thickener were mixed with ion exchange water. As a result, a paste-like composition for forming the heat resistance layer was prepared. Next, the heat resistance layer-forming composition was applied to only one surface of the separator substrate and was dried. As a result, a separator including the heat resistance layer on one surface of the substrate layer was prepared.

The separator according to Example 2 was prepared using the same material and process as in Example 1, except that boehmite (average particle size (D₅₀): 0.2 μm, BET specific surface area: 8 m²/g) as an inorganic filler; an acrylic resin as a binder; and carboxymethyl cellulose (CMC) as a thickener were mixed with ion exchange water to prepare a paste-like composition for forming the heat resistance layer.

The separator according to Example 3 was prepared using the same material and process as in Example 1, except that boehmite (average particle size (D₅₀): 0.2 μm, BET specific surface area: 8 m²/g) as an inorganic filler; an acrylic resin as a binder; and carboxymethyl cellulose (CMC) as a thickener were mixed with ion exchange water to prepare a paste-like composition for forming the heat resistance layer.

The separator according to Example 4 was prepared using the same material and process as in Example 1, except that boehmite (average particle size (D₅₀): 0.2 μm, BET specific surface area: 8 m²/g) as an inorganic filler; an acrylic resin as a binder; and carboxymethyl cellulose (CMC) as a thickener were mixed with ion exchange water to prepare a paste-like composition for forming the heat resistance layer.

The separator according to Example 5 was prepared using the same material and process as in Example 1, except that boehmite (average particle size (D₅₀): 0.2 μm, BET specific surface area: 8 m²/g) as an inorganic filler; polyvinyl pyrrolidone (PVP) as a binder; and poly(N-vinylacetamide) (PNVA) as a thickener were mixed with ion exchange water to prepare a paste-like composition for forming the heat resistance layer.

The separator according to Example 6 was prepared using the same material and process as in Example 1, except that boehmite (average particle size (D₅₀): 0.2 μm, BET specific surface area: 8 m²/g) as an inorganic filler; polyvinyl pyrrolidone (PVP) as a binder; and poly(N-vinylacetamide) (PNVA) as a thickener were mixed with ion exchange water to prepare a paste-like composition for forming the heat resistance layer.

The separator according to Example 7 was prepared using the same material and process as in Example 1, except that boehmite (average particle size (D₅₀): 0.2 μm, BET specific surface area: 8 m²/g) as an inorganic filler; styrene-butadiene rubber (SBR) as a binder; and poly(N-vinylacetamide) (PNVA) as a thickener were mixed with ion exchange water to prepare a paste-like composition for forming the heat resistance layer.

The separator according to Example 8 was prepared using the same material and process as in Example 1, except that boehmite (average particle size (D₅₀): 0.2 μm, BET specific surface area: 8 m²/g) as an inorganic filler; and an epoxy resin as a binder were mixed with ion exchange water to prepare a paste-like composition for forming the heat resistance layer.

The separator according to Example 9 was prepared using the same material and process as in Example 1, except that magnesia (average particle size (D₅₀): 0.2 μm, BET specific surface area: 9 m²/g) as an inorganic filler; an acrylic resin as a binder; and carboxymethyl cellulose (CMC) as a thickener were mixed with ion exchange water to prepare a paste-like composition for forming the heat resistance layer.

The separator according to Example 10 was prepared using the same material and process as in Example 1, except that titania (average particle size (D₅₀): 0.1 μm, BET specific surface area: 20 m²/g) as an inorganic filler; an acrylic resin as a binder; and carboxymethyl cellulose (CMC) as a thickener were mixed with ion exchange water to prepare a paste-like composition for forming the heat resistance layer.

The separator according to Example 11 was prepared using the same material and process as in Example 1, except that silica (average particle size (D₅₀): 0.2 μm, BET specific surface area: 8 m²/g) as an inorganic filler; an acrylic resin as a binder; and carboxymethyl cellulose (CMC) as a thickener were mixed with ion exchange water to prepare a paste-like composition for forming the heat resistance layer.

The separator according to Example 12 was prepared using the same material and process as in Example 1, except that boehmite (average particle size (D₅₀): 0.2 μm, BET specific surface area: 8 m²/g) as an inorganic filler; an acrylic resin as a binder; and carboxymethyl cellulose (CMC) as a thickener were mixed with ion exchange water to prepare a paste-like composition for forming the heat resistance layer.

The separator according to Example 13 was prepared using the same material and process as in Example 1, except that boehmite (average particle size (D₅₀): 0.2 μm, BET specific surface area: 8 m²/g) as an inorganic filler; an acrylic resin as a binder; and carboxymethyl cellulose (CMC) as a thickener were mixed with ion exchange water to prepare a paste-like composition for forming the heat resistance layer.

In the separator according to Example 14, the separator substrate was used as is (that is, the heat resistance layer-forming composition was not applied).

The separator according to Example 15 was prepared using the same material and process as in Example 1, except that boehmite (average particle size (D₅₀): 0.2 μm, BET specific surface area: 8 m²/g) as an inorganic filler; and an epoxy resin as a binder were mixed with ion exchange water to prepare a paste-like composition for forming the heat resistance layer.

In the inorganic fillers used for the preparation of the separators according to Examples 1 to 15, the average particle size (D₅₀) was measured using a laser scattering particle size analyzer (MICROTRAC HRA, manufactured by Nikkiso Co., Ltd.), and the BET specific surface area was measured using a specific surface area measuring device (manufactured by Shimadzu Corporation). During the preparation of the heat resistance layer-forming compositions according to Examples 1 to 15, using an ultrasonic disperser (CLEARMIX, manufactured by M Technique Co., Ltd.), the components were mixed and kneaded at 15000 rpm for 5 minutes as preliminary dispersing and were mixed and kneaded at 20000 rpm for 15 minutes as main dispersing. The heat resistance layer-forming composition was uniformly applied to the substrate (substrate layer) using a gravure coating method.

The average thickness of the heat resistance layer in the separator according to each example was obtained by analyzing an image obtained using a scanning electron microscope (SEM). The average thickness of the heat resistance layer is shown “Thickness (μm)” of “Heat Resistance Layer” in Table 1. The porosity of the heat resistance layer in the separator according to each example was measured and was within a range of 75 vol % to 90 vol %.

Regarding the separator according to each example prepared as described above, the adhesion strength between the substrate layer and the heat resistance layer was measured by performing a 90° peeling test using a tensile testing machine. The 90° peeling test was performed according to JIS C 6481 (1996). Specifically, first, a test piece having a size of 120 mm×10 mm was cut from each separator. In order to fix the separator substrate (substrate layer) at one end of the test piece in a longitudinal direction to a tensile jig (for example, a clamp), the heat resistance layer at the end of the test piece in the longitudinal direction was peeled off from the separator substrate (substrate layer). Using a double-sided adhesive tape, the heat resistance layer surface of the test piece was adhered to a stand of a tensile testing machine in order to fix the test piece (separator) to the stand of the tensile testing machine. The heat resistance layer-peeled portion (substrate layer) of the test piece was fixed to the tensile jig. The tensile jig was pulled up at a rate of 0.5 mm per second to an upper side (peeling angle: 90±5°) in a direction perpendicular to a surface of the stand (that is, the heat resistance layer adhered to the stand) such that the heat resistance layer was peeled off from the substrate layer. At this time, an average load value in the period of time in which the heat resistance layer was peeled off from the substrate layer was measured, and an average load value per unit width (here, width: 10 mm) was set as the adhesion strength (N/10 mm). The results are shown in “Adhesion Strength (N/10 mm)” of Table 1.

Next, using the following materials and processes, lithium ion secondary batteries (nonaqueous electrolyte secondary batteries) according to Examples 1 to 15 shown in Table 1 were constructed.

The positive electrode was prepared in the following procedure. LiNi_{0.33}Co_{0.33}Mn_{0.33}O₂ (LNCM) as positive electrode active material powder; AB as a conductive material; and PVdF as a binder were weighed at a mass ratio (LNCM:AB:PVdF) of 90:8:2. These weighed materials were mixed with NMP to prepare a positive electrode active material layer-forming slurry. This slurry was applied in a belt shape to both surfaces of elongated aluminum foil (positive electrode current collector) having a thickness of 15 μm, was dried, and was pressed. As a result, a positive electrode sheet was prepared.

The negative electrode was prepared in the following procedure. Graphite (C) as a negative electrode active material; styrene-butadiene rubber (SBR) as a binder; and CMC as a thickener were weighed at a mass ratio (C:SBR:CMC) of 98.6:0.7:0.7. The weighed materials were mixed with ion exchange water. As a result, a negative electrode active material layer-forming slurry was prepared. This slurry was applied in a belt shape to both surfaces of elongated copper foil (negative electrode current collector) having a thickness of 10 μm, was dried, and was pressed. As a result, a negative electrode sheet was prepared.

Using one positive electrode, one negative electrode, and two separators (separators according to any one of Examples 1 to 15) prepared as described above, the wound electrode body according to any one of Examples 1 to 15 was prepared. That is, the positive and negative electrodes were laminated in a longitudinal direction with the separators according to each example interposed therebetween such that active material layer non-forming portions were positioned on opposite sides; and that the heat resistance layer of the separator faced the negative electrode (negative electrode active material layer). A laminate in which the positive electrode, the negative electrode, and the separators were laminated was wound in a longitudinal direction around a winding axis having a true circle shape in section. Next, the laminate was squashed to prepare a flat wound electrode body. The separator was used in combination with the separator having the same configuration (for example, the separators according to Example 1).

Using the above-described method, 10 wound electrode bodies were prepared for each example. Regarding each of the electrode bodies, whether or not manufacturing failure such as the cracking or peeling of the heat resistance layer of the separator, the cracking of the separator, loose winding, or winding failure occurred was determined. The number of wound electrode bodies in which the manufacturing failure occurred was counted for each example. The number of wound electrode bodies in which the manufacturing failure occurred among 10 electrode bodies according to each example is shown in “Manufacturing Failure Number (piece/10 pieces)” of Table 1. Here, when frequency of manufacturing failure was 40% or lower, it was determined that the manufacturing failure was allowable in the manufacturing process of the battery. When frequency of manufacturing failure was 20% or lower, it was determined that the manufacturing failure was suitably suppressed. That is, an example in which the frequency of manufacturing failure was 20% or lower was determined as “Good”, an example in which the frequency of manufacturing failure was 40% or lower was determined as “Acceptable”, and an example in which the frequency of manufacturing failure was higher than 40% was determined as “Unacceptable”. The determination results are shown in “Determination” of Table 1.

Next, the wound electrode body according to each example was accommodated in an square aluminum battery case (square battery case), a nonaqueous electrolytic solution was injected through an opening of the battery case, and the opening was air-tightly sealed. As a result, a lithium ion secondary battery (nonaqueous electrolyte secondary battery) according to each example was prepared. As the nonaqueous electrolytic solution, a solution was used in which LiPF₆ as a supporting electrolyte was dissolved in a mixed solvent at a concentration of 1.1 mol/L, the mixed solvent containing EC, EMC, and DMC at a volume ratio (EC:EMC:DMC) of 30:40:30.

[High-Temperature Holding Test]

A high-temperature holding test of leaving the nonaqueous electrolyte secondary battery according to each example prepared as described above to stand in a high-temperature (about 170° C.) environment was performed. Specifically, first, regarding the lithium ion secondary battery according to each example, the battery case was pressed from outside such that the wound electrode body in the battery case was restrained at a restraining force of 6000 N in a direction perpendicular to the flat surface (flat portion) of the electrode body. After the restraining, the battery according to each example was charged at a constant current at a charging rate of 1 C until the potential between the positive and negative electrode terminals reached 3.3 V. The charged battery was left to stand in a temperature environment of 170° C. for 1 hour. After the standing for 1 hour, the voltage (potential between the positive and negative electrode terminals) of the battery according to each example was measured. Typically, a decrease in the voltage (potential between the positive and negative electrodes) in the high-temperature holding test shows that internal short-circuiting occurred in the electrode body due to the thermal shrinkage of the separator. Accordingly, in the battery in which the voltage was maintained in the high-temperature holding test, the thermal shrinkage of the separator was suppressed, and the heat resistance (high-temperature durability) was high. The high-temperature holding test was performed as described above ten times on the battery according to each example. During ten times of the test, the number of batteries in which the voltage after the standing at a high-temperature was decreased to 3V or lower was counted. The number of wound electrode bodies in which the voltage decrease was found in 10 nonaqueous electrolyte secondary batteries according to each example is shown in “High-Temperature Holding Test (piece/10 pieces)” of Table 1.

TABLE 1

| | | | | | Frequency of | |
|---|---|---|---|---|---|---|
| | | | | | Manufacturing Failure | |
| | Heat Resistance Layer | | Adhesion | High-Temperature | Manufacturing | |
| | Inorganic | Thickness | Strength | Holding Test | Failure Number | |
| Example | Filler | (μm) | (N/10 mm) | (piece/10 pieces) | (piece/10 pieces) | Determination |
| 1 | Alumina | 2 | 0.19 | 0 | 0 | Good |
| 2 | Boehmite | 2 | 0.19 | 0 | 0 | Good |
| 3 | Boehmite | 5 | 0.19 | 0 | 0 | Good |
| 4 | Boehmite | 5 | 0.21 | 0 | 0 | Good |
| 5 | Boehmite | 5 | 0.58 | 0 | 0 | Good |
| 6 | Boehmite | 5 | 1.18 | 0 | 0 | Good |
| 7 | Boehmite | 5 | 98 | 0 | 2 | Good |
| 8 | Boehmite | 5 | 400 | 0 | 4 | Acceptable |
| 9 | Magnesia | 5 | 0.82 | 0 | 0 | Good |
| 10 | Titania | 5 | 0.82 | 0 | 0 | Good |
| 11 | Silica | 5 | 0.80 | 0 | 0 | Good |
| 12 | Boehmite | 2 | 0.05 | 9 | 0 | Good |
| 13 | Boehmite | 5 | 0.04 | 8 | 0 | Good |
| 14 | None | — | — | 10 | 0 | Good |
| 15 | Boehmite | 5 | 2600 | — | 10 | Unacceptable |

As shown in Table 1, in the batteries according to Examples 1 to 11, the voltage decrease in the high-temperature holding test was suppressed. That is, in the separator in which the adhesion strength between the substrate layer and the heat resistance layer was 0.19 N/10 mm to 400 N/10 mm, the peeling of the heat resistance layer from the substrate layer is reduced; as a result, the shrinkage of the separator in a high-temperature environment was significantly suppressed. In addition, in the battery including the wound electrode body which was constructed using the separator, high-temperature durability was superior. In the batteries according to Examples 1 to 11, the frequency of manufacturing failure during the manufacturing of the wound batteries was suppressed to be allowable in the manufacturing process of the batteries. In particular, in the batteries according to Examples 1 to 7 and Examples 9 to 11 in which the adhesion strength between the substrate layer and the heat resistance layer in the separator was 98 N/10 mm or lower, the frequency of manufacturing failure during the manufacturing of the wound electrode bodies was significantly suppressed. That is, in the separator in which the adhesion strength between the substrate layer and the heat resistance layer in the separator was 0.19 N/10 mm to 400 N/10 mm (in particular, 98 N/10 mm or lower), the handleability is superior when the wound electrode body was prepared using the separator. It was found from the above results that, by adjusting the adhesion strength between the substrate layer and the heat resistance layer in the separator to be 0.19 N/10 mm to 400 N/10 mm, a separator having high heat resistance which is suitable for manufacturing a wound electrode body can be provided, and a nonaqueous electrolyte secondary battery including the separator which has high reliability (internal short-circuiting is significantly suppressed) can be provided.

On the other hand, in the battery according to Example 14 including the separator in which the heat resistance layer was not formed and in the batteries according to Examples 12 and 13 including the separator in which the adhesion strength between the substrate layer and the heat resistance layer was excessively lower than the above-described range, the voltage decrease in the high-temperature holding test occurred with high frequency (that is, high-temperature durability was poor). The reason for this is presumed to be as follows: since the separators used in these batteries (separators according to Examples 12 to 14) were thermally shrunk in a high-temperature environment, internal short-circuiting occurred. In the battery according to Example 15 including the separator in which the adhesion strength between the substrate layer and the heat resistance layer was higher than the above-described range, the stiffness of the separators was excessively high; as a result, a wound electrode body was not able to be prepared (manufacturing failure: 100%).

It was found from the results of Examples 1 and 9 to 11 that not only boehmite but also alumina, magnesia, titania, and silica can be preferably used as the filler used in the heat resistance layer according to embodiments of the invention.

Hereinabove, specific examples of the invention have been described in detail. However, the embodiment and the examples are merely exemplary and do not limit the invention. The invention includes various modifications and alternations of the above-described specific examples.

What is claimed is:

1. A nonaqueous electrolyte secondary battery comprising:
a flat wound electrode body in which an elongated positive electrode, an elongated negative electrode, and an elongated separator which electrically separates the positive electrode and the negative electrode from each other overlap each other and are wound in a longitudinal direction; and
a nonaqueous electrolyte, wherein
the separator includes a substrate layer which is formed of a resin substrate and a heat resistance layer which is provided on one surface of the substrate layer,
the heat resistance layer contains a filler and a binder, and
an adhesion strength between the substrate layer and the heat resistance layer is 0.19 N/10 mm to 400 N/10 mm.

2. The nonaqueous electrolyte secondary battery according to claim 1, wherein
the adhesion strength between the substrate layer and the heat resistance layer is 0.58 N/10 mm to 98 N/10 mm.

3. The nonaqueous electrolyte secondary battery according to claim 1, wherein
the flat wound electrode body is obtained by winding the positive electrode, the negative electrode, and the separator in a cylindrical shape to obtain a wound electrode body and then pressing the wound electrode body in a direction perpendicular to a winding axis to be formed into a flat shape.

4. A battery pack comprising:
a plurality of the nonaqueous electrolyte secondary batteries according to claim 1 that are electrically connected to each other, wherein
the flat wound electrode body included in each of the nonaqueous electrolyte secondary batteries is restrained at a restraining pressure of 100 N to 20000 N in a direction perpendicular to a flat surface of the flat wound electrode body, and
a difference between a restraining force applied to curved portions of the flat wound electrode body and a restraining force applied to the flat surface is 50 N or higher.
